(19) United States
(12) Patent Application Publication
(10) Pub. No.: US 2025/0208491 A1
(43) Pub. Date: Jun. 26, 2025

(54) APPARATUS, METHOD, AND SYSTEM FOR FINE TUNING OF CAPTURE DEVICES

(71) Applicant: Musco Corporation, Oskaloosa, IA (US)

(72) Inventors: Logan J. Bogatzke, Eddyville, IA (US); Matthew D. Drost, Oskaloosa, IA (US); Jacob W. Taylor, Oskaloosa, IA (US); David J. Van Ee, Oskaloosa, IA (US)

(73) Assignee: Musco Corporation, Oskaloosa, IA (US)

(21) Appl. No.: 18/851,127

(22) PCT Filed: Mar. 31, 2023
(86) PCT No.: PCT/US2023/017155

§ 371 Date: Sep. 26, 2024

Related U.S. Application Data
(60) Provisional application No. 63/362,263, filed on Mar. 31, 2022.

(51) Int. Cl. G03B 17/56; G01B 11/27; G01C 9/24

(52) U.S. Cl. CPC G03B 17/561; G01B 11/27; G01C 9/24

(57) ABSTRACT

It is well known that in the case of devices designed to capture content—for example, cameras (both still and video), microphones, sensors, and other devices—there is a motivation to both reduce installation time and installation error, and so some degree of partial assembling, wiring, aiming, and/or commissioning occurs in a factory setting before shipment. However, many such devices require fine tuning on site after at least preliminary installation. Discussed are apparatus and method for fine tuning that does not rely on conventional means of site power and/or internet access.

### CROSS-REFERENCE TO RELATED APPLICATIONS

This application is a National Stage application claiming priority to and the benefit of International Patent Application No. PCT/US2023/017155, filed Mar. 31, 2023, which claims the benefit of Provisional Application U.S. Ser. No. 63/362,263 filed on Mar. 31, 2022, each of which are hereby incorporated by reference in their entirety.

### I. TECHNICAL FIELD OF INVENTION

The present invention generally relates to field aiming of devices (e.g., cameras). More specifically, the present invention relates to devices which are typically at least partially assembled, wired, aimed, and/or commissioned in a factory setting, but require some degree of onsite adjustment or further commissioning (hereinafter “fine tuning”). More specifically still, the present invention relates to fine tuning of devices when conventional means (e.g., wirelessly connecting to the devices for remote aiming) are unavailable (e.g., internet access has not yet been installed at the site).

### II. BACKGROUND OF THE INVENTION

It is well known that in the case of devices designed to capture content—for example, cameras (both still and video), microphones, sensors, and other devices (hereinafter “capture devices”)—there is a motivation to both reduce installation time and installation error. To this end, oftentimes capture devices are at least partially factory assembled, wired, aimed, and/or commissioned; see, for example, U.S. patent U.S. Pat. No. 11,306,861 B1 granted Apr. 19, 2022, incorporated by reference herein in its entirety, which includes a discussion of capture devices. Capture devices encompass any number of devices (including connection, power means, communication means, etc.) capable of acquiring or capturing and/or transmitting (e.g. live streaming, recording) content (e.g., video, images, sound, electromagnetic energy) associated with a site or venue, or an event at a site or venue.

That being said, it is oftentimes inevitable that some degree of fine tuning of capture devices must be completed in the field after installation—for example, cameras intended to capture a narrow field of view with a long setback might need to be rotated, tilted, pivoted, etc. (hereinafter “adjusted”) after installation such that a landmark (e.g., home plate) is centered in the field of view or a feature (e.g., the horizon) is in the correct orientation (e.g., appears truly horizontal).

Herein lies a problem. Often sites are in varying degrees of construction when at least partially factory assembled, wired, aimed, and/or commissioned capture and distribution systems such as those described in U.S. Pat. No. 11,306,861 B1 are installed, and a lack of power and/or internet access prevents the installer from powering up the devices and completing fine tuning using conventional means.

Thus, there is room for improvement in the art.

### III. SUMMARY OF THE INVENTION

It is well known that there is a benefit to at least partially assembling, wiring, aiming, and/or commissioning capture devices in a factory-type setting before shipment. However, as has been stated, there is often a need to fine tune said capture devices in the field after installation—even if said assembling, wiring, aiming, and/or commissioning has occurred—and if a site is so rudimentary that power and/or internet access is not yet available, conventional means of fine tuning (e.g., remotely connecting to said capture devices) is not possible.

It is therefore a principal object, feature, advantage, or aspect of the present invention to improve over the state of the art and/or address problems, issues, or deficiencies in the art.

Envisioned is a small aiming apparatus, and method for operating such, which can be installed inside a housing of a capture device while still at the factory, and which can be operated after said capture device is at least preliminarily installed at a site to complete fine tuning.

Further objects, features, advantages, or aspects of the present invention may include one or more of the following:
a. said aiming apparatus being compact and interfacing with other capture device assembly components such that a new capture device housing is not needed;
b. said apparatus having means for determining, correlating, and/or adjusting at least one of a vertical, horizontal, or rotational orientation; and
c. said method of operation not requiring site power or internet access.

These and other objects, features, advantages, or aspects of the present invention will become more apparent with reference to the accompanying specification and claims.

### IV. BRIEF DESCRIPTION OF THE DRAWINGS

From time-to-time in this description reference will be taken to the drawings which are identified by figure number and are summarized below.

FIG. 1 illustrates an overview of a typical site which might include one or more capture devices which may benefit from aspects according to the present invention; note that for clarity, only one capture device is illustrated.

FIGS. 2 and 3 illustrate perspective views of a capture device; note that for clarity all internal components and electrical connections have been omitted.

FIGS. 4-12 illustrate various views of the capture device of FIGS. 2 and 3 as modified according to a first embodiment. FIG. 4 illustrates a partially exploded perspective view of the capture device with the first embodiment apparatus installed (note some fastening devices have been omitted), and FIGS. 5-12 illustrate a perspective view, an alternative perspective view, a front view, a back view, a top view, a bottom view, a left side view, and a right side view, respectively, of the first embodiment apparatus in isolation.

FIGS. 13-21 illustrate various views of the capture device of FIGS. 2 and 3 as modified according to a second embodiment. FIG. 13 illustrates a partially exploded perspective view of the capture device with the second embodiment apparatus installed (note some fastening devices have been omitted), and FIGS. 14-21 illustrate a perspective view, an alternative perspective view, a front view, a back view, a top view, a bottom view, a left side view, and a right side view, respectively, of the second embodiment apparatus in isolation.

FIG. 22 illustrates one possible method of operating the apparatuses of FIGS. 4-21 so to provide fine tuning of the capture device of FIGS. 2 and 3 according to aspects of the present invention.

### V. DETAILED DESCRIPTION OF EXEMPLARY EMBODIMENTS

### A. Overview

To further an understanding of the present invention, specific exemplary embodiments according to the present invention will be described in detail. Frequent mention will be made in this description to the drawings. Reference numbers will be used to indicate certain parts in the drawings. Unless otherwise stated, the same reference numbers will be used to indicate the same parts throughout the drawings.

Regarding terminology, the terms “device”, “component”, “part”, “portion”, and “feature”—in the singular or in the plural—are used more-or-less interchangeably herein; the same can be said for “site” and “venue”. Use of one term over another is by way of convenience, and not by way of limitation. Also, as previously discussed, the term “fine tuning” is generally defined herein as including some degree of onsite adjustment or further commissioning of capture devices—though could also encompass full adjustment or commissioning of capture devices after installation (e.g., some vertical adjustment is provided in a factory setting and some is provided on site, but all horizontal adjustment is provided on site during fine tuning). Likewise, the term “capture devices” is generally defined herein as devices designed to capture content—for example, cameras (both still and video), microphones, sensors, and other devices. Lastly, the term “adjusted”—including its root word and other variations of the term—is generally defined herein as rotated, tilted, pivoted, etc. (including their root words and other variations of the terms).

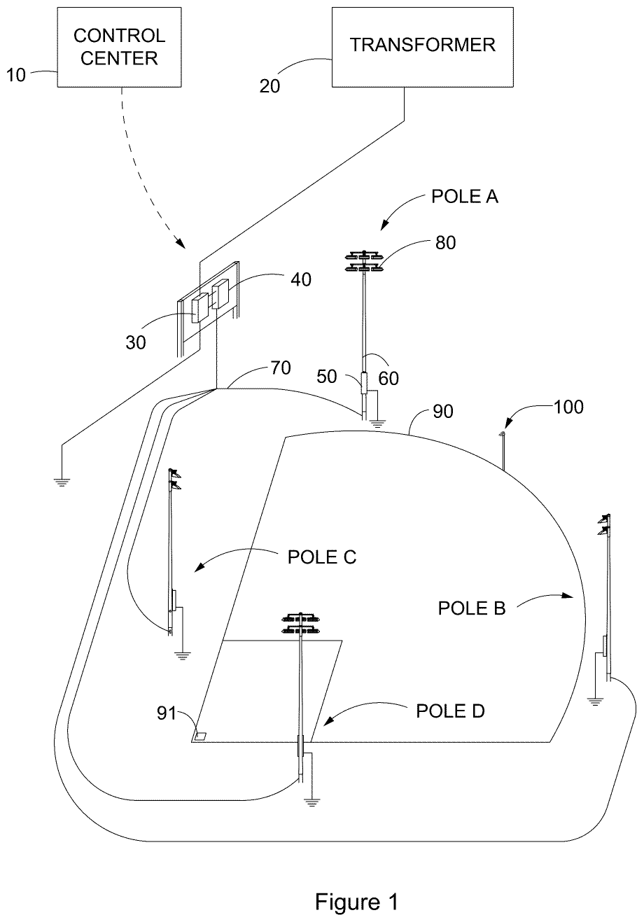

The exemplary embodiments envision modification of a capture device such as or similar to those described in aforementioned U.S. Pat. No. 11,306,861 B1 so to include an apparatus (two embodiments of which are discussed) which permits fine tuning without external power or internet access according to a method later described. For illustrative purposes (and not by way of limitation), consider a sports lighting site such as that illustrated in FIG. 1. Here, a transformer 20 delivers power to a distribution cabinet 30 which is distributed to each lighting fixture 80 at each pole 60 via power lines 70 which are conditioned for the specific lighting load at pole cabinets 50; this is well known in the art of sports lighting. Typical sports lighting installations, and other lighting systems for controlled lighting to large areas, have plural poles 60 or other elevating structures (FIG. 1 shows four by example and not limitation, namely Poles A, B, C, and D), and each pole or elevating structure typically has a plurality of individual light fixtures (two or more, and sometimes ten or more). There can be one or more capture device(s) associated with each venue or even each pole. Oftentimes some kind of facility management system 10—such as is described in U.S. Pat. No. 7,778,635 incorporated by reference herein—controls the array of lights via remote operation of contactors or other power means in a control cabinet 40 such that they illuminate a venue 90 at desired times; note venue 90 oftentimes not only includes a field of play, but a three-dimensional space proximate the field of play (e.g., to illuminate balls in flight).

Accordingly, it is desirable to install and position capture devices to capture content relevant to said venue 90, at one or more relevant times; for example, capture devices might only be actively recording video when game play is detected (e.g., via a sensor of said capture device). To ensure adequate coverage of the entire field of play, multiple capture devices might be installed with multiple streams of video and other data taken from multiple points/perspectives—and collectively fed to facility management system 10. Therefore, to ensure video can be stitched together, or to ensure seamless transition between video streams, or for any other number of reasons, it is beneficial for all capture devices to be fine-tuned relative to a common feature; for the example of softball and baseball one such feature is home plate 91 (FIG. 1).

However, it should be noted that at times capture device assemblies 100 in a centerfield position can be located up to and just over 400 feet from home plate 91, which is itself a very small object in comparison. Therefore, any apparatus for fine tuning must have a relatively high number of selectable iterations in a particular direction (e.g., in a vertical direction to adjust downward/upward from a mounted location and in a rotational direction to adjust a plane in the field of view to appear more-or-less horizontal)—in addition to being compact (e.g., so it can fit in the housing of the capture device) and low cost (e.g., so it can be left in place after use instead of removed).

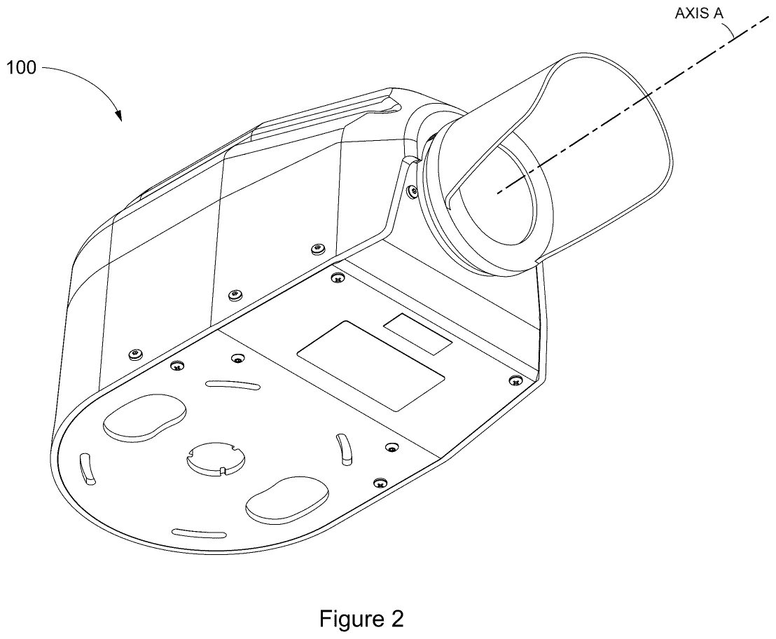

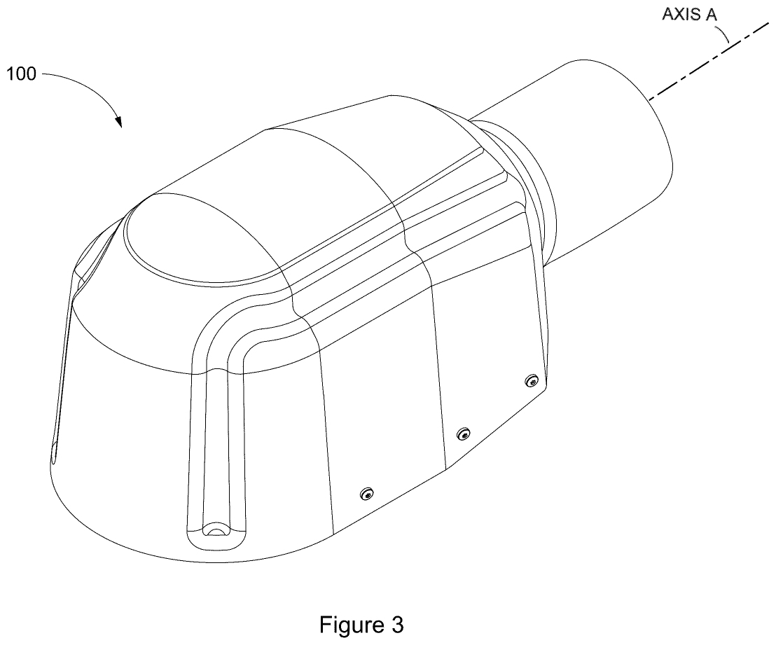

Two exemplary embodiments, utilizing aspects of the generalized example described above, and illustrated with one non-limiting example of a capture device assembly 100 (e.g. camera) as in FIGS. 2 and 3, will now be described.

### B. Exemplary Method and Apparatus Embodiment 1

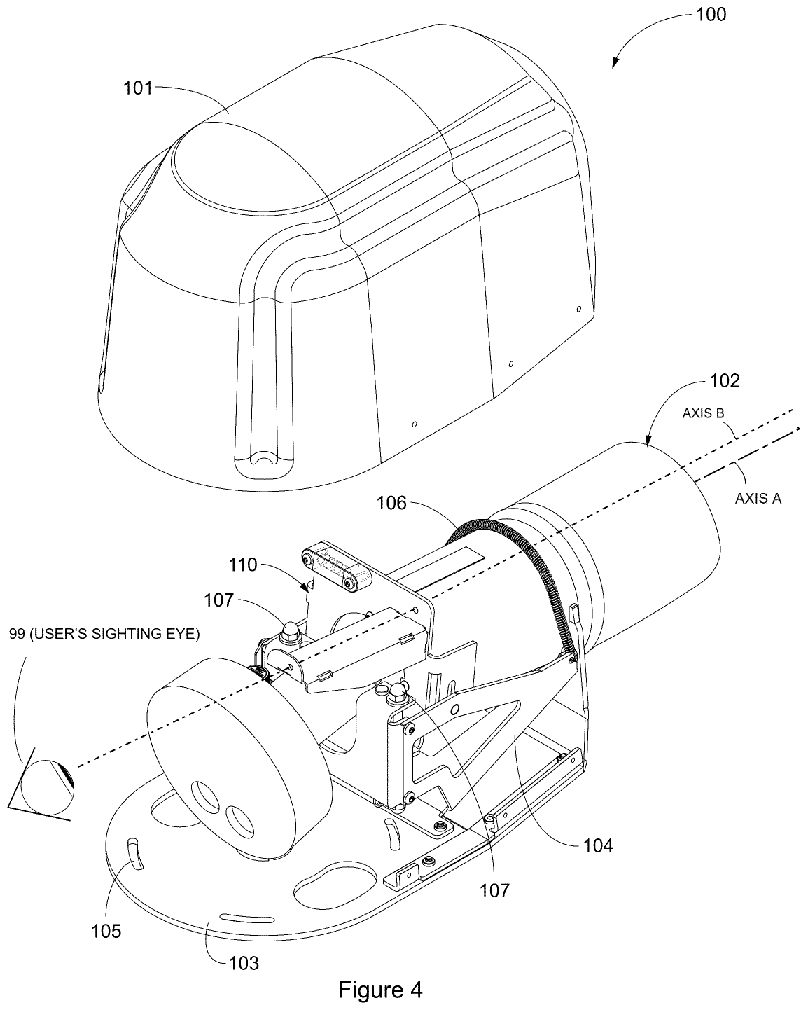

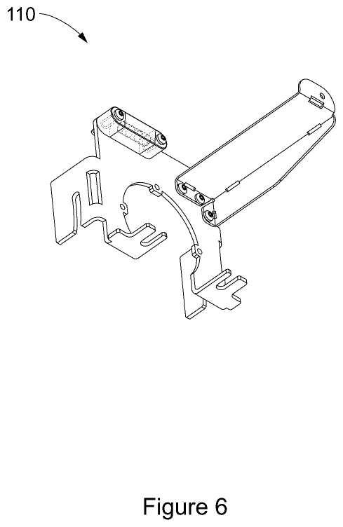

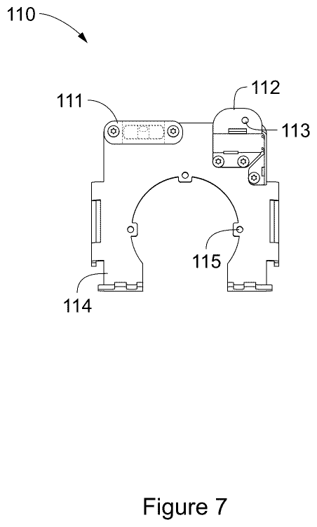

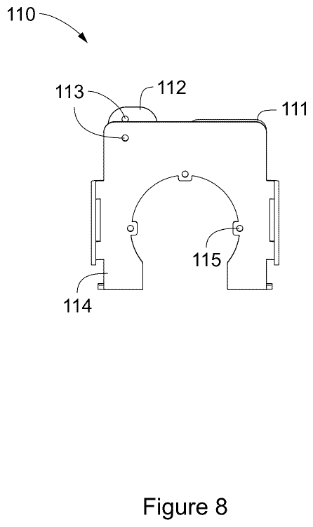

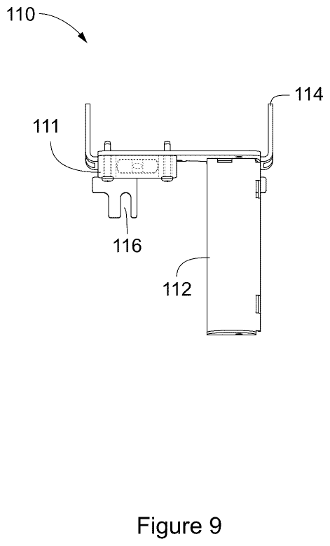

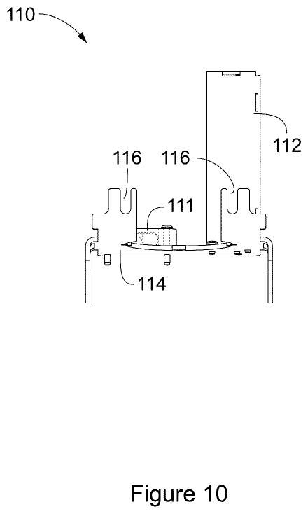

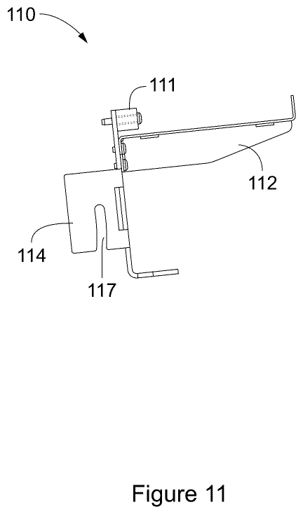

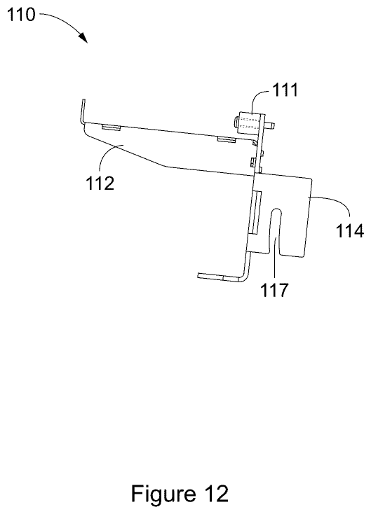

Taking again the example of a sports lighting application and a capture device assembly comprising a centerfield camera assembly 100, a first embodiment of fine tuning apparatus 110 may be as is illustrated in FIGS. 4-12. As can be seen from FIG. 4, fine tuning apparatus 110 is entirely contained in an interior space of capture device assembly 100 as defined by an outer housing 101 and base 103, said base 103 having means 105 for horizontal adjustment (later discussed). Fine tuning apparatus 110 is designed to at least partially surround, and be installed in a known relationship to the aiming axis A of capture device 102 (here, a model Q1700-LE camera available from Axis Communications Inc., Chelmsford, MA, USA). Capture device 102 is resiliently fixed at a front end by spring 106, and adjusted at a back end via part 104, which in combination with acorn nuts 107 and fine tuning apparatus 110, permits vertical and rotational adjustment of capture device 102 and its aiming axis A (later discussed).

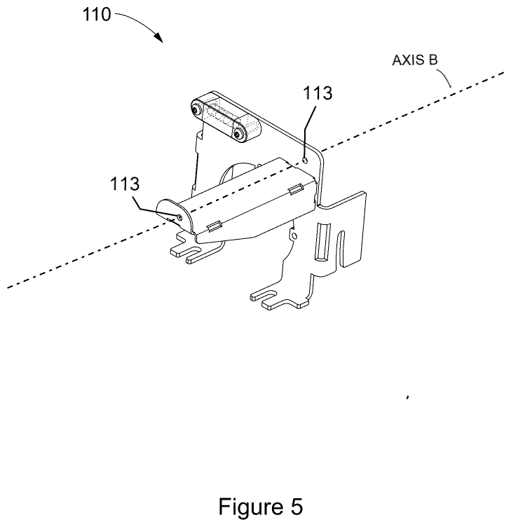

To interface with other portions of capture device assembly 100, and to provide aforementioned determining, correlating, and/or adjusting at least one of a vertical or rotational orientation, fine tuning apparatus 110 includes a number of features; see FIGS. 5-12. For the specific example illustrated in FIGS. 1-3 (i.e., a centerfield camera at a baseball field aimed to home plate), portion 112 of fine tuning apparatus 110 is on the order of 5 inches long, and including at least one sight aperture 113 measuring 3/16 inch in diameter having sight aiming axis B (see FIGS. 4 and 5) parallel to the device aiming axis A of camera 102, albeit at an offset, for this example, of 4 inches above the aiming axis A (here, the centerline) of camera 102. There could be a pair of sight apertures 113 aligned and spaced apart along sighting axis B (see FIG. 5) (similar to a gun sight with two spaced apart sighting structures along the gun barrel). Alternatively, a single aperture 113 in the portion 112 could be used to sight over the top edge of body 114 where level 111 is mounted. FIG. 4 shows the relative dimensional size of portion 112 to the other components of fine tuning apparatus 110, including housing 101 and the space inside housing 101 when attached to base 103, for this specific example. As will be appreciated, this example illustrates how the fine tuning apparatus 112 can be of a relatively small and compact size and fit within that space defined by housing 101 when attached to base 103 without interference with the operation of capture device 102 or capture device assembly 100. As will be appreciated, these features of compactness and non-interference can apply similarly to other capture devices and capture device assemblies. A number of apertures 115/116/117 are included in body 114 so to secure fine tuning apparatus 110 in situ (e.g., when fastening devices are used). Lastly, an inexpensive and readily available bubble level 111 (preferably in a transparent housing so to be viewable from multiple angles, though this is by way of example and not by way of limitation) aids in verifying correct rotational orientation to capture device 102 and its aiming axis A (later discussed).

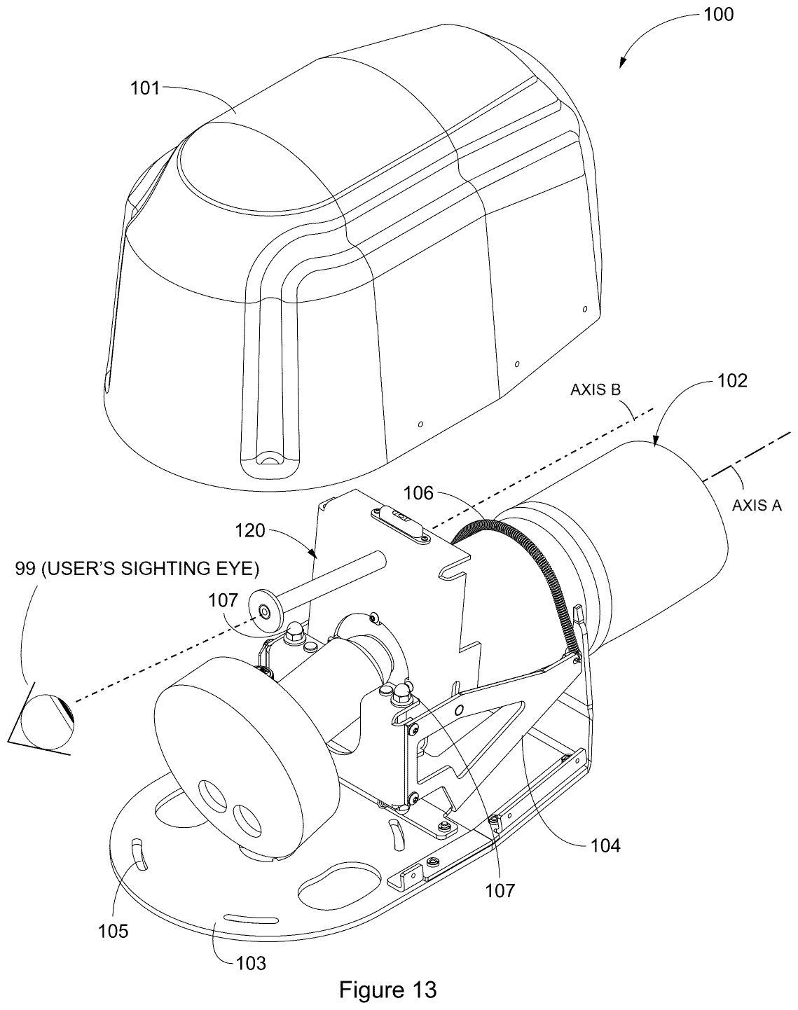

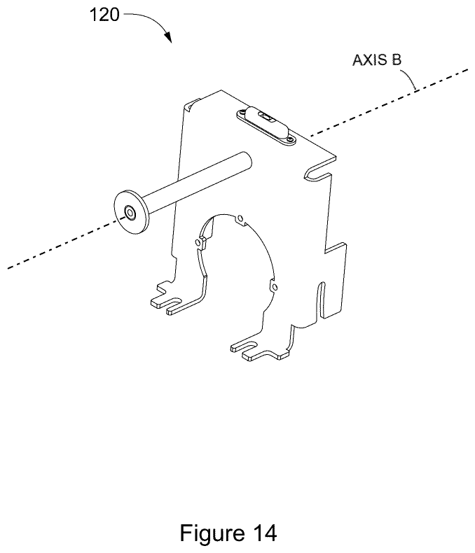

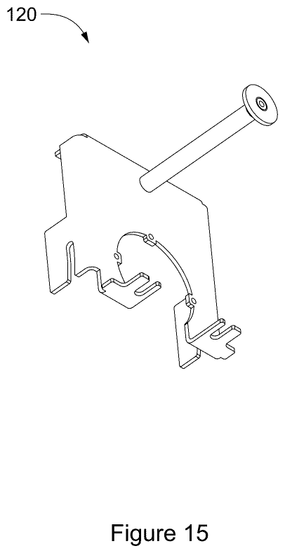

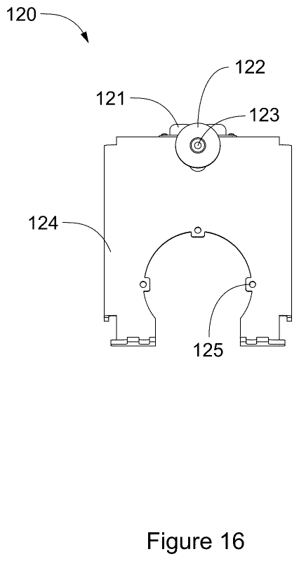

As can be seen, the sighting technique of portion 112 is a simple, passive, physical marker, or set or system of physical markers or front and rear aiming pieces or sights, that allow a user to look at or through with the user's eye 99 (shown diagrammatically at FIGS. 4 and 13) to align the sight aiming axis B with a target on or related to the venue. Sight marker(s) 113 (or 123) can be of a variety of forms. Non-limiting examples are aperture(s) (sometimes referred to as closed sight(s)) or notch(es) (sometimes referred to as open sight(s)), or a combination of them. Because the sight(s) of fine tuning apparatus 110 or 120 is/are mounted to capture device assembly 100 such that the sight aiming axis B is parallel with the device aiming axis A, there is a pre-established and known correlation between the two so that sighting to a desired target at the venue (usually tens if not hundreds of feet away) provides an effective approximation of the aiming of the capture device with which the fine tuning apparatus is used.

### C. Exemplary Method and Apparatus Embodiment 2

An alternative embodiment in accordance with aspects of the present invention envisions a fine tuning apparatus 120 which is similar to that of Embodiment 1; note parts 111, 112, 113, 114, 115, 116, and 117 of Embodiment 1 correlate in relative size and function to parts 121, 122, 123, 124, 125, 126, and 127 of this Embodiment 2. The primary difference between Embodiments 1 and 2 are in the construction of the fine tuning apparatus. Here, for example, portion 122 is formed from a threaded tube material (e.g., aluminum alloy) which is secured on the generally opposite side of body 124 with a complementary nut. A benefit to the present embodiment is such that a straightness of part 122 is more certain than the straightness of part 112, though the single-piece nature of body 124 combined with the higher cost of tubing for part 122 (as opposed to part 112) means an overall higher cost to produce fine tuning apparatus 120 than fine tuning apparatus 110.

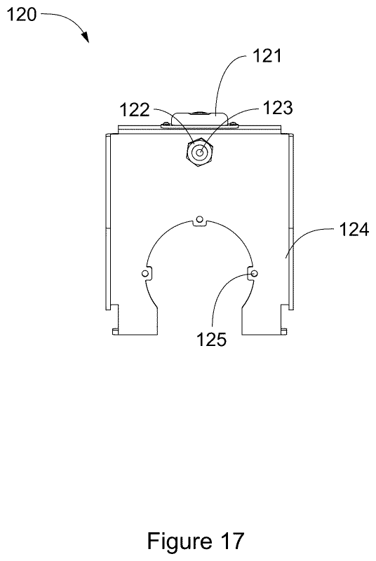

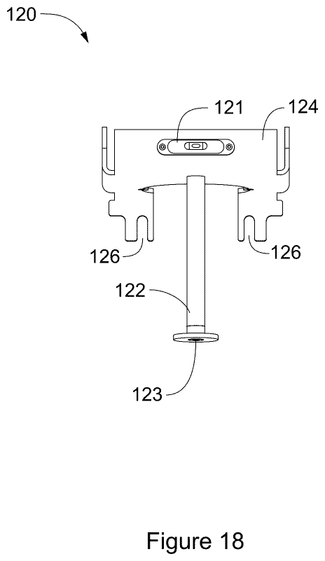

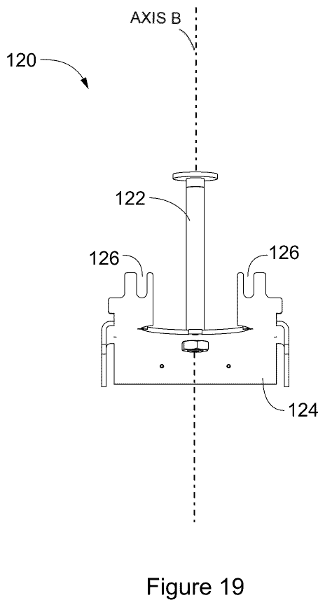

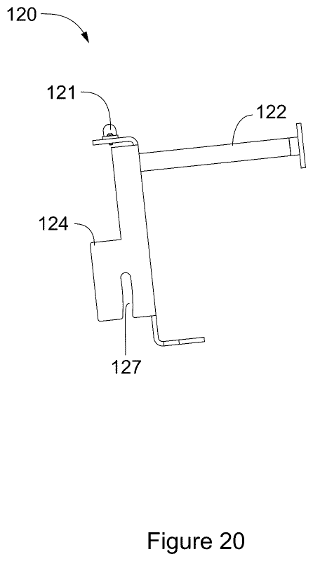

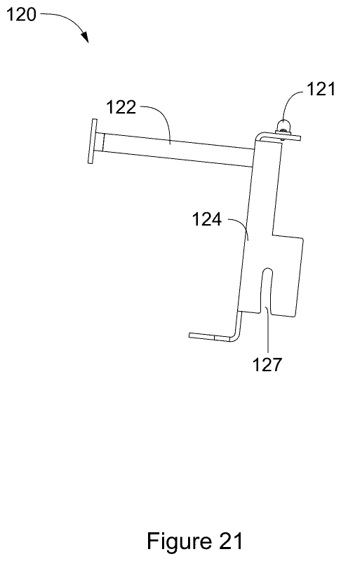

In embodiment 2, the user's eye 99 sights through a first open end 123 (FIG. 18) of tube 122, through tube 122, and then out a second open end 123 (FIG. 17), all aligned along sight aiming axis B, to a target at or related to the venue. Axis B has a known correlation (e.g. parallel) to the device 102 aiming axis A. This is another example of a simple passive visual alignment sight.

### D. Exemplary Method

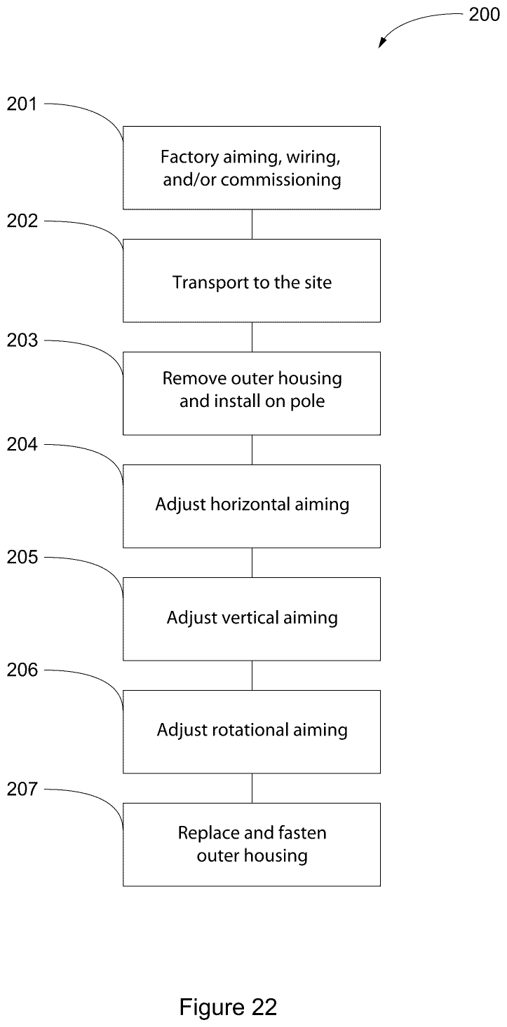

One possible method of operating fine tuning apparatus 110/120 to provide fine tuning of a capture device in a capture device assembly such as that illustrated in FIGS. 2 and 3 for a venue such as that illustrated in FIG. 1 is illustrated in FIG. 22 according to method 200 (or other venues for which capture devices of this type might be used). As a first step 201, typically some degree of assembling, aiming, wiring, and/or commissioning of at least one portion of a capture device assembly is completed in a factory setting; of course, this can vary depending on the type of capture device and the application, for example. For the present example, step 201 might include setting device 102 in a preliminary operating orientation within the interior space and securing spring 106, as well as parts 104 and assembly 110 (or 120). Acorn nuts 107 could be tightened to set a rough vertical and rotational orientation. Then, housing portion 101 could be secured to base portion 103 (e.g., via fastening devices on brackets) so to enclose the interior space so that capture device assembly 100 may be shipped to a site (step 202). Step 201 might additionally include such things as setting IP addresses of devices, completing electrical connections, and the like. Examples of wide-area network connectivity to and from a capture device can be seen, e.g., at U.S. Pat. No. 11,306,861 B1.

Once on site, outer housing 101 is removed so that base 103 can be mated with a pole or other support structure (see FIG. 1) according to step 203, though in practice installation is only preliminary (e.g., fastening devices are not fully tightened) so to allow horizontal adjustment (step 204) via pivoting of base 103 in the direction of and to the degree defined by apertures 105. In practice, for the example of baseball or softball fields as shown in FIG. 1, capture device assemblies mounted at a centerfield position are actually mounted several degrees either left or right of a pitcher's mound (at or near the middle of the diamond-shaped area in FIG. 1 which includes home plate 91 at one corner) on poles approximately 12 feet tall so to have a clear line-of-sight to gameplay; hence why horizontal adjustment forms a part of fine tuning on site. As such, an installer may twist and pivot base 103 until the image of home plate 91 is more-or-less centered in sight aperture 113/123 in a horizontal plane before fully tightening fastening devices and moving to the next step of method 200. The installer would look with one eye 99 through the sight(s) 113 or 123, holding proper eye 99 position, and simultaneously focus on the sight(s) 113 or 123 and a target, all at different distances, and align all planes of focus. It is a simple visual aligner.

According to steps 205 and 206 vertical and rotational orientation is adjusted, respectively. In practice, steps 205 and 206 could occur one after the other (or step 206 before 205), but it is more likely the steps are combined according to iterative adjustments to acorn nuts 107. For example, tightening or loosening both acorn nuts 107 (e.g., via nut driver) the same amount will raise or lower the back side of capture device 102 (the front end being fixed via spring 106), and thus, adjust vertical orientation. However, if one acorn nut 107 is raised or lowered more than the other, the result is rotational orientation. In this manner, an installer may adjust none, one, or both of acorn nuts 107—in combination with maintaining a desired level as determined by bubble level 111/121—all the while keeping home plate 91 (or some other perceivable physical target at or related to a venue) centered in sight aperture 113/123. For the most extreme cases (e.g., a centerfield camera with a 400 feet radius field), centerfield cameras need only be adjusted approximately 1 degree up or down in a vertical plane, so having a high number of selectable iterations that can be selected and unselected as needed—as is provided by a relatively continuously adjustable device like an acorn nut, as opposed to a keyed mechanical device with distinct adjustment levels, for example—is essential to steps 205 and 206.

After fine tuning is complete, according to step 207 outer housing 101 is replaced by placing it in its operational orientation and affixing to base 103 (e.g., via fastening devices)—with fine tuning apparatus 110/120 still installed in the interior space. Given that fine tuning is such an iterative process with such fine degrees of adjustment, it is likely that the very process of removing fine tuning apparatus 110/120 would cause misalignment of capture devices; hence why fine tuning apparatus 110/120 is of a size and cost so to allow it to be left in place after use instead of being removed.

### E. Options and Alternatives

The invention may take many forms and embodiments. The foregoing examples are but a few of those. To give some sense of some options and alternatives, a few examples are given below.

Exemplary embodiments have been described with respect to a particular application (i.e., a sports venue), at a particular mounting location and designed for a specific purpose (i.e., for a baseball or softball sports venue at or near center field, aimed to home plate, and designed to capture game play near home plate), with a specific type of capture device and associated housing. It is to be noted that all of the aforementioned can differ and not depart from at least some aspects according to the present invention for different capture devices, and different installations and venues for the capture device(s). For the example of a sport venue as in FIG. 1, mounting heights may be tall enough (e.g., upwards of 30 feet) such that centerfield cameras need not be installed several degrees left or right of the pitcher's mound, and therefore not only is structure different, but method 200 may also be different insomuch that it may not require step 204. As another example, the type of capture device may differ—for example, instead of a camera installed at or near center field, a capture device may comprise a microphone or other sensor installed in a different housing and behind home plate. Still further, structure used to provide adjustment need not be as described and illustrated herein; for example, a plurality of springs with adjustable tensions/compressions could be used instead of acorn nuts. Even further, a capture device may not have an associated housing at all, and therefore fine tuning apparatus 110/120 may not need to be installed in an interior space (instead perhaps being affixed directly to the capture device (fixedly or removably)). Again, all of the aforementioned are possible, and envisioned. Such considerations and variations based on the same may be relevant to, and used in analogous ways, regarding any of a variety of different capture devices and how they are used or applied to any of a variety of venues.

Finally, while much discussion has been had regarding the benefits of at least partially assembling, wiring, aiming, and/or commissioning capture devices in a factory setting, this is not required to benefit from at least some aspects according to the present invention. For example, all wiring could be completed on site during fine tuning. Also, adjustment in one, two, or three planes (i.e., horizontal, vertical, and/or rotational) is not required to benefit from at least some aspects according to the present invention. It is possible in some rare cases that a capture device assembly may already be well aligned upon installation—this can be determined, verified, or otherwise correlated using fine tuning apparatus 110/120, and so still benefits from such.

What is claimed is:

1. A method of fine tuning a device comprising:
a. completing one or more initial steps during assembly of the device in a factory setting;
b. installing a fine tuning assembly by affixing said fine tuning assembly to at least a portion of a component associated with the device;
c. installing said device with said installed fine tuning assembly at a site; and
d. adjusting at least one of a horizontal, vertical, or rotational orientation of the device by aligning the fine tuning assembly with a feature at the site.

2. The method of claim 1 wherein the one or more initial steps comprises one or more of:
a. assembling;
b. aiming;
c. wiring; or
d. commissioning.

3. The method of claim 1 wherein the component associated with the device comprises a housing which at least partially encloses said device.

4. The method of claim 3 wherein the housing is removable and defines an interior space, and wherein the fine tuning assembly is compact relative to the housing, and has an overall size that fits within the interior space of the housing without disruption of operation of the device when the cover is installed to enclose the device.

5. The method of claim 4 further comprising:
a. after factory assembly, transporting the device with installed fine tuning assembly to the site;
b. removing the housing and install the device with installed fine tuning assembly on a pole or elevating structure at the site;
c. adjust one or more of horizontal, vertical, or rotational aiming of the a fine tuning assembly by visual alignment sighting with a feature at the site; and
d. replacing the housing.

6. The method of claim 1 wherein the device has a device aiming axis and the fine tuning assembly has one or more visual sights defining a sight aiming axis, the fine tuning assembly is affixed to the component of the device so that the sight aiming axis is in a known correlation to the device aiming axis, and the aligning comprises visual alignment of one or more visual sights of the fine tuning assembly with the feature of the site.

7. The method of claim 6 wherein each of the one or more visual sights comprises one of an open sight or a closed sight.

8. The method of claim 6 wherein the feature of the site comprises a landmark or a perceivable location at a venue or site.

9. The method of claim 6 wherein the aligning of the one or more visual sights of the fine tuning assembly with a feature at the site comprises an installer looking with an eye through the one or more visual sights, holding a proper eye position, and simultaneously focusing on the one or more visual sights and the feature of the site, all at different distances, and aligning all planes of focus.

10. A fine tuning apparatus comprising:
a. a body adapted for mounting in a capture device;
b. a length of material operatively connected to the body; and
c. a visual alignment sight along the length of the material.

11. The apparatus of claim 10 wherein the body includes one or more parts for interfacing with, or otherwise connecting to:
a. a housing;
b. a base;
c. a capture device; or
d. an assembly.

12. The apparatus of claim 10 wherein the length of the material and a size of the visual alignment sight are correlated to effective visual alignment with a feature associated with a site that is tens or hundreds of feet away.

13. The apparatus of claim 12 wherein the effective visual alignment comprises effectiveness for an installer looking with an eye through the visual alignment sight, holding a proper eye position, and simultaneously focusing on the visual alignment sight, and the feature of the site, all at different distances, and aligning all planes of focus.

14. The apparatus of claim 10 wherein the visual alignment sight comprises one or more visual sights.

15. The apparatus of claim 14 wherein the one or more visual sights comprises a closed sight.

16. The apparatus of claim 14 wherein each of the one or more visual sights comprises an open sight or a closed sight.

17. The apparatus of claim 10 further comprising a leveling device wherein the leveling device comprises a bubble level.

18. The apparatus of claim 10 in combination with a device to be fine tuned, wherein the device includes a removable housing that defines an interior space, and wherein the fine tuning apparatus is compact relative to the housing, and has an overall size that fits within the interior space of the housing without disruption of operation of the device when the cover is installed to enclose the device.

19. The combination of claim 18 wherein the device has a device aiming axis and the fine tuning apparatus has a sight aiming axis, the fine tuning apparatus is affixed to the device so that the sight aiming axis is in a known correlation to the device aiming axis.

20. The combination of claim 18 wherein the device comprises a capture device.

21. A fine tuning apparatus comprising:
a. a body;
b. a length of material operatively connected to the body;
c. a sighting aperture extending along the length of the material; and
d. a leveling device.
